(19) United States
(12) Patent Application Publication
(10) Pub. No.: US 2003/0161160 A1
(43) Pub. Date: Aug. 28, 2003

(54) Light fixture assembly

(76) Inventor: Giuseppe Caluori, Dollard-des-Ormeaux (CA)

Correspondence Address: MIDDLETON & REUTLINGER, 2500 BROWN & WILLIAMSON TOWER, LOUISVILLE, KY, 40202

(21) Appl. No.: 10/139,458

(22) Filed: May 6, 2002

(30) Foreign Application Priority Data
Feb. 28, 2002 (CA) 2,371,950

(51) Int. Cl. F21S 8/06

(52) U.S. Cl. 362/404

(57) ABSTRACT

A light fixture assembly is provided with a lamp housing having a top, a lamp socket within the lamp housing, and a power pack operatively connected to the lamp socket, and a means for supported attachment of the power pack to the lamp housing at a position substantially lateral to the lamp housing, and not extend substantially above a plane defined by the top of the lamp housing. The power pack comprises a junction box and a transformer operatively connected to the lamp socket, and means for operative attachment of the power pack to an electrical source. The means for supported attachment of the power pack to the lamp housing permit flexion of the junction box relative to the lamp housing.

### CROSS-REFERENCE TO RELATED APPLICATIONS

This application claims the benefit of Canadian patent application number 2,371,950, filed Feb. 28, 2002.

### STATEMENT REGARDING FEDERALLY SPONSORED RESEARCH OR DEVELOPMENT

Not applicable.

### FIELD OF THE INVENTION

The present invention relates to junction boxes, power packs and transformers for ceiling mounted light fixtures.

### BACKGROUND OF THE INVENTION

Ceiling mounted lights such as pot lights are typically constructed with the light bulb housed within a substantially lamp cylindrical housing upon which is mounted a transformer and an electrical junction box for connection to an electrical source. Conventional ceiling mounted light fixtures were typically constructed in a linear format, such the transformer and junction box were stacked upon the lamp housing. A light fixture having this stacked configuration is typically greater than 6 inches in height.

In older buildings, 8 inch by 2-inch joists were commonly used to support floors. The use of these joists would result in a plenum of approximately 7 inches between the underside of a floor and the ceiling of the level below. Conventional ceiling mounted light fixtures having heights between 6 and 7 inches could be installed within the 7-inch plenum without difficulty.

In recent years, there has been a trend toward reducing the height of the joists between floors in order to reduce building costs. The use of joists having dimensions of approximately 6 inches by 2 inches has been introduced into residential construction projects. Correspondingly, there has been a reduction in plenum heights, and it is more common to have plenum heights of approximately 6 inches in recent commercial and residential buildings. Reduced plenum heights may also be found in the context of renovations and building re-construction projects. If there has been a redesign of the interior of a building, other service access such as air conditioning ducting may be routed through the existing plenum, reducing the height available for ceiling mounted light fixtures. Conventional light fixtures having a stacked configuration of lamp housing, junction box and transformer cannot be installed in building projects where the plenum is less than the standard 7 inches.

It is desirable when installing ceiling mounted light fixtures to cut a single hole in the ceiling of approximately the size of the lamp housing, and to insert the light fixture into the plenum through this opening. Installation of this type avoids the need to close up a larger installation opening once the light fixture is installed. A flanged external frame is mounted to the installed light fixture to provide an attractive finished appearance.

It is an object of the present invention to provide a light fixture for a ceiling mounted light, which can be installed within plenum spaces that are of a height that is less than the standard 7-inch plenum.

It is a further object of the present invention to provide a light fixture for a ceiling mounted light which can be installed within plenum spaces though a relatively small opening in the ceiling, of a size and shape which will ultimately contain the light housing.

### SUMMARY OF THE INVENTION

In accordance with an aspect of the present invention, there is provided a light fixture assembly having a lamp housing having a top, a lamp socket within the lamp housing and a power pack operatively connected to the lamp socket, and a means for supported attachment of the power pack to the lamp housing at a position substantially lateral to the lamp housing, and not extending substantially above a plane defined by the top of the lamp housing. The power pack comprises a transformer operatively connected to the lamp socket and a junction box containing means for operative attachment of the power pack to an electrical source. The means for supported attachment of the power pack to the lamp housing permit flexion of the power pack relative to the lamp housing.

### BRIEF DESCRIPTION OF THE DRAWINGS

The invention will be better understood and its advantages will become more apparent to those skilled in the art by reference to the following drawings, in conjunction with the accompanying specification, in which:

FIG. 1 is a top plan view of a light fixture according to the present invention;

FIG. 2 is a cross section of the light fixture taken along line A-A of FIG. 1.

### DETAILED DESCRIPTION OF EMBODIMENTS

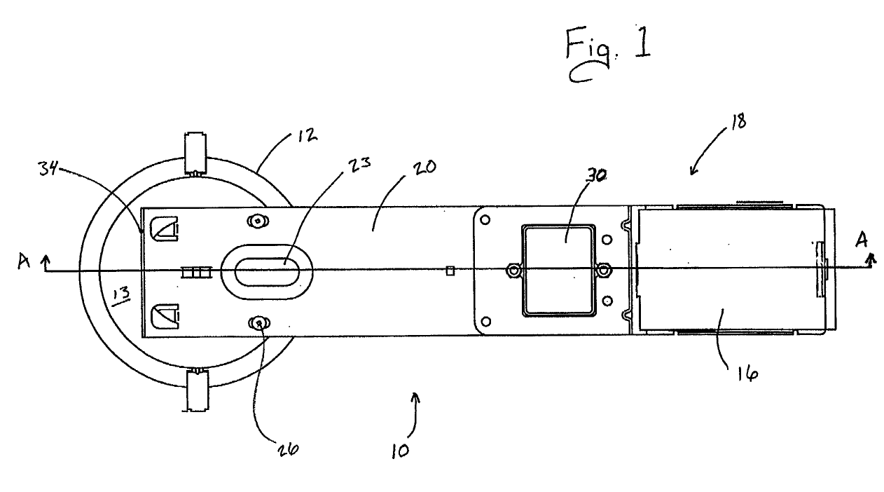

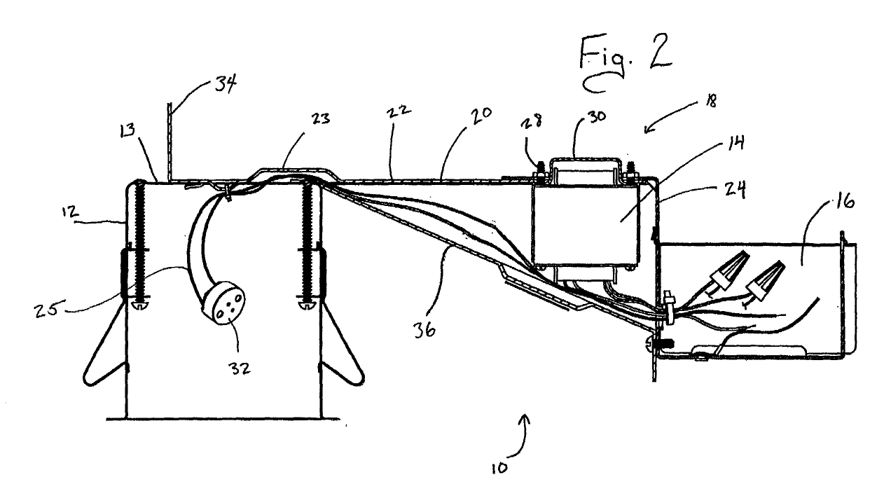

Referring to FIGS. 1 and 2 there is shown a light fixture assembly generally identified by reference numeral 10. The light fixture assembly 10 has a lamp housing 12 with a top 13. The lamp housing 12 is supportably attached to transformer 14, which in turn is supportably attached to a junction box 16. Together, the transformer 14 and the junction box 16 form a power pack 18 shown by general reference numeral 18.

A means 20 is provided for supported attachment of the power pack 18 to the lamp housing 12 at a position substantially lateral to the lamp housing 12. The power pack 18 in supported attachment to the lamp housing 12 does not extend substantially above a plane defined by the top 13 of the lamp housing 12. This positioning of the power pack 18 substantially laterally to and not extending substantially above the lamp housing 12 permits the light fixture assembly 10 to be installed in spaces which have little vertical clearance, such as in a plenum between floors of a residential building.

The means 20 for supported attachment of the power pack 18 to the lamp housing 12 may permit flexion relative to the lamp housing 12. As seen in FIGS. 1 and 2, the attachment means 20 preferably comprises a front channel top 26, which is mounted to the lamp housing 12 by fasteners such as screws 20 and locating tabs 22. The front channel top 22 extends laterally from the top 13 of the lamp housing 12. In the preferred embodiment shown, the front channel top 22 is constructed from sheet metal, and there is a measure of flexion of the front channel top 22 inherent in the nature of the metal. An embossment 23 is provided on the front channel top 22 to permit clearance above the lamp 12 housing to facilitate the through passage of wires 26 for operative connection of the power pack 18 to the lamp socket 32. The front channel top 22 also has a height requirement tab 34.

The front channel top 22 is in turn mounted to a transformer cap 30 secured to the transformer 14. Such mounting is accomplished by conventional fasteners such as screws 28.

As discussed above, the light fixture assembly 10 further comprises a junction box 16 containing means for operative attachment of the light fixture assembly 10 to an electrical source. The junction box 16 operatively connected to the transformer 14, together, form the power pack 18. A means is provided for the supported attachment of the junction box 16 to the transformer 14. In the preferred embodiment, the attachment means comprises a back channel top 24, which is also mounted to the transformer cap 30 secured to the transformer 14. For simplicity of assembly the back and front channel tops can both be mounted using the same screws 28.

As shown in the figures, the front channel 22 and the back channel 24 together form the attachment means for supported connection of the power pack 18 to the lamp housing 12. In the preferred embodiment, the channels are separate elements, which are both mounted to the transformer cap 30. It should be understood that a single attachment means attached to each of the lamp housing 12, the transformer cap 30 and the junction box 16 could also be employed within the scope of the present invention.

As shown in FIG. 2, a protective shield may be attached to the lamp housing 12 and the junction box 16 to enclose the transformer 14 and the wires which provide operative connection of between the lamp socket 28, the transformer 14 and operative connection within the junction box 16 to an electrical source.

The light fixture assembly is installed by first inserting the power pack through an opening cut in a ceiling for access to a plenum (not shown). Once the power pack is entirely within the plenum it will come to rest on the upper surface the ceiling, which forms the lower limit of the plenum. The lamp housing can then be inserted into the opening in the ceiling and secured in the installed position using biased locking tabs or by other securing means. Once installed, the power pack rests in a position lateral to the lamp housing 12, and the power pack does not extend substantially above the plane defined by the top of the lamp housing. Accordingly, the present invention results in light fixture assemblies, which can be readily installed in shallow plenums.

It will be obvious to those skilled in the art that the structural and functional principles of the present invention need not be limited to compact light fixtures, but could also be utilized in other lighting applications.

Thus, it will be apparent that the scope of the present invention is limited only by the claims set out hereinbelow.

What is claimed is:

1. A light fixture assembly comprising:
a lamp housing having a top;
a lamp socket within the lamp housing;
a transformer operatively connected to the lamp socket; and,
a means for supported attachment of the transformer to the lamp housing at a position substantially lateral to the lamp housing.

2. The light fixture assembly of claim 1 wherein the transformer does not extend substantially above a plane defined by the top of the lamp housing.

3. The light fixture assembly of claim 2 further comprising:
a junction box containing means for operative attachment of the light fixture assembly to an electrical source, said junction box operatively connected to the a transformer; and,
a means for supported attachment of the junction box to the transformer at a position substantially lateral to the transformer not extending substantially above a plane defined by the top of the lamp housing.

4. The light fixture assembly of claim 3 wherein the means for supported attachment of the transformer to the lamp housing permits flexion of the transformer relative to the lamp housing.

5. The light fixture assembly of claim 4 wherein the means for supported attachment of the transformer to the lamp housing comprises a front channel top attached to the lamp housing.

6. The light fixture assembly of claim 5 wherein the front channel top further comprises an embossment to permit clearance of the channel top above the housing to facilitate the throughpassage of wires for operative connection of the lamp socket, the transformer and an electrical source.

7. The light fixture assembly of claim 6 wherein the front channel top further comprises a height requirement tab.

8. The light fixture assembly of claim 3 wherein the means for supported attachment of the junction box to the transformer comprises a back channel top attached to the transformer and to the front channel top.

9. The light fixture assembly of claim 8 further comprising a protective shield attached to the lamp housing and the junction box to enclose the transformer and the wires.

10. A power pack for use with a light having a lamp socket within a lamp housing, the power pack comprising:
a transformer adapted for operative connection to the lamp socket;
a junction box having means for operative attachment of the power pack to an electrical source;
a means for supported attachment of the transformer to the junction box; and,
a means for supported attachment of the power pack to the lamp housing at a position substantially lateral to the lamp housing.

11. The power pack of claim 10 wherein the means for supported attachment of the power pack to the lamp housing permits flexion of the power pack relative to the lamp housing.

12. The power pack of claim 11 further comprising a protective shield attached to the lamp housing and the junction box to enclose the transformer and the wires.

13. A light fixture assembly comprising:
a lamp housing having a top;
a lamp socket within the lamp housing;
power pack operatively connected to the lamp socket; and,
a means for supported attachment of the power pack to the lamp housing at a position offset from the lamp housing.

14. The light fixture assembly of claim 13 wherein the power pack does not extend substantially above a plane defined by the top of the lamp housing.

15. The light fixture assembly of claim 14 wherein the power pack comprises:
a transformer adapted for operative connection to the lamp socket;
a junction box having means for operative attachment of the power pack to an electrical source; and,
a means for supported attachment of the transformer to the junction box.

16. The light fixture assembly of claim 15 further comprising a protective shield attached to the lamp housing and the junction box to enclose the transformer and the wires.
